(19) United States
(12) Patent Application Publication
(10) Pub. No.: US 2005/0289159 A1
(43) Pub. Date: Dec. 29, 2005

(54) Web-enabled real-time link selection apparatus and method

(75) Inventors: Brent L. Hadley, Kent, WA (US); Patrick J. Eames, Newcastle, WA (US); Susan C. Chew, Issaquah, WA (US)

Correspondence Address: BLACK LOWE & GRAHAM, PLLC, 701 FIFTH AVENUE, SUITE 4800, SEATTLE, WA, 98104, US

(73) Assignee: The Boeing Company, Chicago, IL (US)

(21) Appl. No.: 10/879,291

(22) Filed: Jun. 29, 2004

(51) Int. Cl. G06F 17/00

(52) U.S. Cl. 707/100

(57) ABSTRACT

A system and method for selective enablement and/or disablement of referential links is disclosed. In one embodiment, a document management system includes a database configured to store document trees having referential links embedded therein, a processor that communicates with the database and with a client device operable to access selected portions of the document trees and actuate selected links, and an information control unit coupled to the processor to control a status of the referential links in the accessed portions according to predetermined criteria. In another embodiment, a method of selectively altering a status of a link includes initiating a document request from a database having a plurality of document trees with embedded referential links, reviewing access information associated with the request, altering the status of a referential link in the requested document based upon the access information, and transferring the document to a client device.

### FIELD OF THE INVENTION

This invention relates generally to a system and method for information management, and more particularly, to a system and method for selective enablement of referential links in a document.

### BACKGROUND OF THE INVENTION

In recent years, commercial enterprises have increasingly transferred documents of various types into information databases that may be directly accessed by a user. Information databases offer a level of convenience to a user because they do not require the user to access physical volumes containing indexed information, or to access drawing files, and the like. Similarly, the use of information databases is advantageous to commercial enterprises because it allows significant cost savings. For example, the information database generally supports “paperless” operation, thus generally eliminating paper and printing costs. The use of information databases also largely eliminates the substantial floor space requirements generally associated with document libraries, filing cabinets and drawing files, which are typically used to store paper documents. Most importantly, the use of information databases significantly reduces the amount of time a user must devote to acquiring needed documents.

The database architecture generally dictates how data is stored within the database and further, how data stored in the database is accessed. In many instances, the database has a hierarchical architecture, so that information in the database is accessed first through a main directory that provides a list of general topics that are similar in content and function to a table of contents in a book. Instead of page number references as in a table of contents, the main directory provides semantic associations that define paths between the general topics in the main directory and underlying sub-topical information in the database.

In order to assist a user of a database, referential links are often placed in various selected locations within a database, so that a user may quickly navigate from a source location to a destination location, as defined by the link. For example, the source location may be located in a first document in the database, and the destination location may be a second document in the database, or even in an entirely different database. One example of a referential link is the well-known hyperlink commonly found in hypertext systems. To actuate a hyperlink, a user simply points to the hyperlink and selects it by pressing a button on a mouse or other similar peripheral device. The user then directly views the content associated with the hyperlink.

Accordingly, referential links provide a convenient method for rapidly moving from one portion of a database to another, or to move from one database to an entirely different one. Where a referential link has been provided, a user thus avoids the need to “drill down” through the various levels in the database, or to exit the database and to access a new database in order to find related information of interest.

While it may be desirable to provide a user with access to all portions of a database, it may also be desirable to selectively limit access to a destination location provided in a referential link. For example, in cases where the source document and the destination document include information that may be widely disseminated, the link may be used as previously described, since there is no information in either the source document or the destination document that is of a confidential nature. On the other hand, where the source document includes information that is not confidential, and the destination document includes confidential information, it may be desirable to selectively disable the referential links that provide a path to the confidential information for users that exist outside a group authorized to view the confidential information.

What is needed in the art is an apparatus and a method that permits the selective enabling and/or disabling of referential links in a document.

### SUMMARY OF THE INVENTION

The present invention comprises a system and method for the selective enablement and/or disablement of referential links. In one aspect in accordance with the invention, a document management system includes a database configured to store one or more document trees having a plurality of referential links embedded therein, a processor configured to communicate with the database and with one or more client devices operable to access selected portions of the one or more document trees and actuate selected links within the accessed portions of the one or more document trees, and an information control unit coupled to the processor and configured to control a status of the referential links in the accessed portions according to predetermined criteria. In another aspect, a method of selectively altering a status of a referential link includes initiating a document request from a database that includes a plurality of document trees having embedded referential links, reviewing access information associated with the document request, altering the status of one or more referential links in the requested document based upon the access information, and transferring the requested document to a client device coupled to the database.

### BRIEF DESCRIPTION OF THE DRAWINGS

The preferred and alternative embodiments of the present invention are described in detail below with reference to the following drawings.

FIG. 1 is a block diagram of a system for selectively enabling and/or disabling referential links according to an embodiment of the invention;

FIG. 2 is a block diagram of a processor of the system shown in FIG. 1;

FIG. 3 is a flowchart of a method of selectively enabling and/or disabling links embedded in a document according to another embodiment of the invention; and

FIG. 4 is a graphical representation of a plurality of hierarchical document trees that will be used to describe a method of selectively linking documents according to another embodiment of the invention.

### DETAILED DESCRIPTION OF THE INVENTION

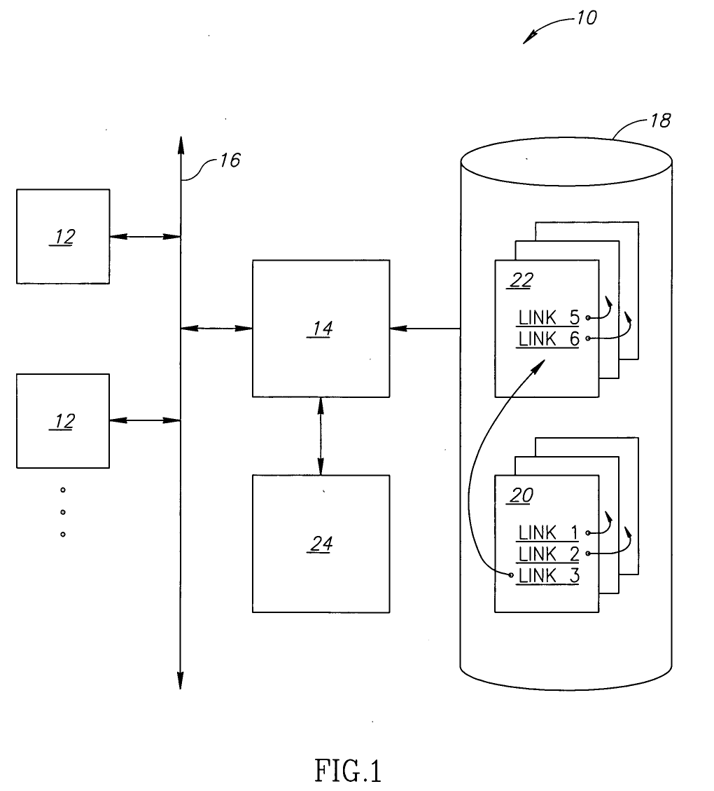

The present invention relates to a system and method for selective enablement of referential links in a document. Many specific details of certain embodiments of the invention are set forth in the following description and in FIGS. 1 through 4 to provide a thorough understanding of such embodiments. One skilled in the art, however, will understand that the present invention may have additional embodiments, or that the present invention may be practiced without several of the details described in the following description.

FIG. 1 is a block diagram of a system 10 for selectively enabling and/or disabling referential links according to an embodiment of the invention. The system 10 includes one or more client devices 12 that are coupled to a processor 14 by a communications network 16, such as the Internet and/or the World Wide Web (WWW). The client devices 12 may include self-contained computing devices having a display screen, a central processing unit, and a magnetic disk drive for persistent mass storage, such as a laptop or desktop computer. Alternately, the client devices 12 may also include one or more data terminals operable to communicate information with the processor 14 through the communications network 16. The processor 14 generally includes any programmable electronic device configured to receive programming instructions and information, and to process the information according to the programming instructions, such as a network server, or other similar devices. The processor 14 will be described in greater detail below.

The processor 14 is coupled to a database 18 that is configured to provide a mass information storage capability, and further includes one or more linked document trees. For clarity of illustration, the database 18 includes a first document tree 20 and a second document tree 22, although one skilled in the art will readily understand that the database 18 may include a plurality of document trees. The first document tree 20 and the second document tree 22 each include a plurality of documents having embedded links that permit navigation within a selected document tree, or between distinct document trees when a user activates the link. For example, LINK 1 and LINK 2 permit movement within the first document tree 20, while LINK 3 permits movement to a selected portion of the second document tree 22. LINK 5 and LINK 6 correspondingly provide for further movement within the second document tree 22.

The processor 14 is further coupled to an information control unit 24 that controls the information that is transferred from the database 18 to the client devices 12. In particular, the information control unit 24 provides instructions to the processor 14 regarding the enablement of links in the document trees stored in the database 18. For example, a selected client device 12 may request access to the first document tree 20. Since the information control unit 24 generally controls the enablement of LINK 1, LINK 2 and LINK 3, the access may be provided with all of the links fully enabled, so that LINK 3 may be activated by a user of the client device 12 to access the second document tree 22. In contrast, the information control unit 24 may also provide that a selected portion of the links in the first document tree 20 be enabled, while others are disabled. For example, if it is desired to restrict the access of a client device 12 to the first document tree 20, LINK 3 may be disabled, while LINK 1 and LINK 2 remain enabled. Accordingly, the information control unit 24 controls which of the client devices 12 are to receive access to documents residing in selected document trees by selectively enabling and/or disabling links in the selected tree.

In a particular embodiment, the links present in all document trees residing in the database 18 may be enabled in a default state, and then selectively disabled by the information control unit 24 depending upon criteria associated with a requesting user. Correspondingly, and in another particular embodiment, the links present in all document trees residing in the database 18 may be disabled in the default state, and then selectively enabled by the information control unit 24 depending again upon criteria associated with a requesting user, as will be discussed below.

Still referring to FIG. 1, the information control unit 24 may enable and/or disable links based upon various criteria associated with the requesting user. For example, in another particular embodiment, links in a requested document may be disabled and/or enabled according to an identity of the requesting user, so that a user that is not authorized to view proprietary information cannot access the document containing the proprietary information because the link has been disabled. In another exemplary embodiment, the links in a requested document may be disabled and/or enabled according to a content of the requested document. For example, all links in a requested technical document may be enabled, while links in the technical document containing financial information are disabled.

In still another exemplary embodiment, a controlling criterion may involve when a requested document may be accessed. For example, airplane maintenance information may be obtained through electronic databases such as the Portable Maintenance Aid (PMA), available from The Boeing Company of Chicago, Ill. The PMA includes aircraft maintenance information in a readily accessible format so that maintenance personnel may conveniently obtain desired maintenance information and view the information on a viewing device. The information maintained on the PMA may be revised according to a predetermined schedule, so that users of the PMA receive the most up-to-date information. The updated information may, however, depend upon the continuous payment of a subscription fee so that links to the updated information may be disabled if the fee has not been received. In still yet another exemplary embodiment, a controlling criterion may involve where a requesting user is located. For example, if links in a requested document provide access to information under a security classification, the links may be disabled if the requestor is located outside of a secure communications system, and may only be enabled when the requestor is located within the secure system.

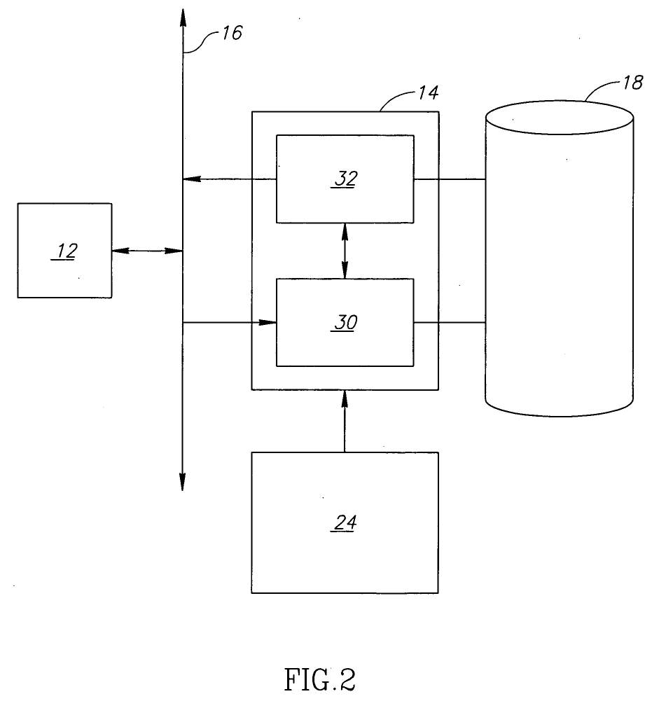

With reference now to FIG. 2, the processor 14 will now be described in further detail. The processor 14 includes a request processor 30 that receives a document request from the client device 12 through the communications network 16. The processor 30 interprets the request and compares the request with access information obtained from the information control unit 24. The information control unit 24 retains the access information as metadata. Accordingly, if the request indicates that the requestor (based upon an identity of the requester, or upon the location of the client device 12, or according to any of the foregoing criteria) is not entitled to have selected links activated in the requested document, information regarding the affected links is transferred to a document processor 32. Based upon the information received from the request processor 30, the document processor 32 formats the requested document and transfers the document through the communications network 16 and to the client device 12. The document processor 32 may prepare a document overlay that includes the information regarding link enablement that is imposed on the affected document and transferred to the client device 12 as a single document. Alternately, the document overlay, once constructed by the document processor 32, may be transferred to the client device 12 as a separate document so that the document overlay may be applied to the requested document at the client device 12, which may improve document handling speeds for the system 10.

Still referring to FIG. 2, in a particular embodiment, the document trees residing in the database 18 may be hypertext documents written in the well-known Hypertext Markup Language (HTML) so that the hypertext documents include hyperlinks. The document request may be identified by a Uniform Record Locator (URL) that includes an identification of the communications protocol, such as conventional and secure hypertext protocols, file transfer protocol (FTP) and the like, the identification of the processor 14 and the database 18 where the document trees reside, as well as the directory name and the file name of the desired document tree. The requested document is accordingly processed as an HTML document in the document processor.

The document trees residing in the database 18 may include links that are generated by a system that automatically generates the links and stores the links in a referential database, as disclosed in our co-pending, commonly-owned U.S. patent application Ser. No. __/___,___, entitled “SYSTEM AND METHOD FOR GENERATING AND STORING REFERENTIAL LINKS IN A DATABASE”, filed May __, 2004, under attorney docket number BOEI-1-1256, which application is incorporated by reference herein. Briefly, and in general terms, the referential database includes referential links extracted from data structures that are correlated according to selected association or “business rules” and stored in a database in discrete data fields. The data structure disclosed in the foregoing application may include, for example, an extended markup language (XML) document having semantic tags that describe particular data elements therein. The data structure is, in turn, generated from a written document. For example, the data structure may be generated from an electronic document formatted in the well-known portable document format (PDF), or it may include a paper document that is scanned into an electronic document using optical character recognition (OCR) methods, as disclosed in our co-pending, commonly-owned U.S. patent application Ser. No. __/___,___, entitled “DOCUMENT INFORMATION MINING TOOL”, filed Apr. 30, 2004 under attorney docket number BOEI-1-1257, which application is also incorporated by reference herein.

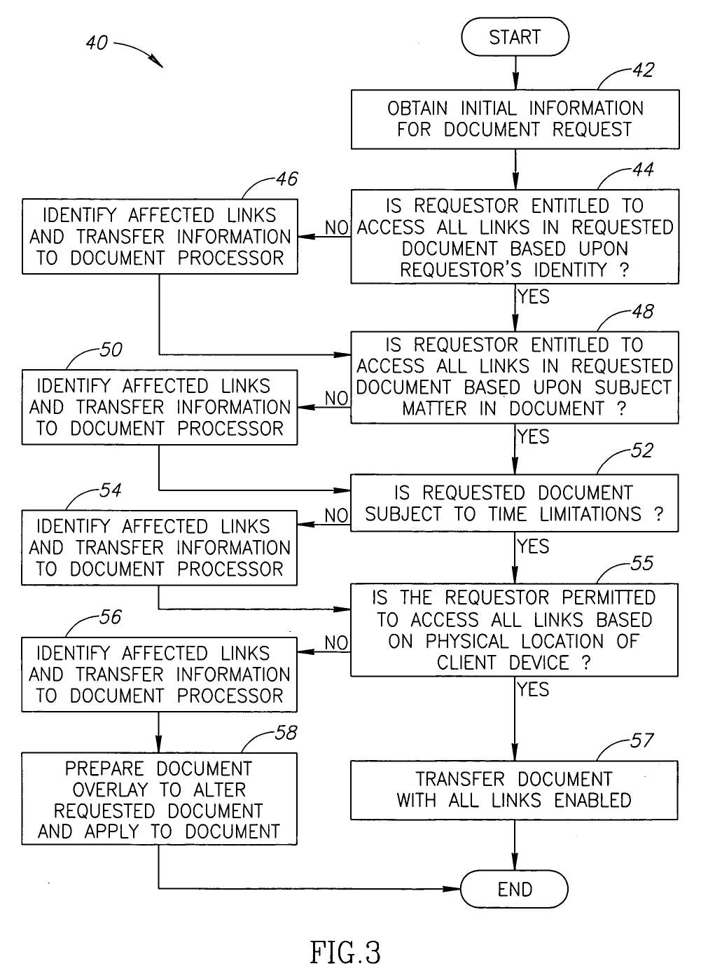

FIG. 3 is a flowchart of a method 40 of selectively enabling and/or disabling links embedded in a document according to another embodiment of the invention. At block 42, information regarding a document request is accepted. As discussed more fully above, the document request is accompanied by an identification of the requestor and the specific document requested. At block 44, the identity of the requestor is processed to determine if the requestor is entitled to receive access to linked documents based upon the identity of the requestor. If the requestor is not entitled to access all of the documents linked to the requested document, the affected links are identified and information pertaining to the links is forwarded to the document processor 32 (of FIG. 2), as shown at block 46.

The method 40 proceeds to block 48, and the document is further processed to determine if the requestor may access all documents linked to the requested document based upon the subject matter of the linked documents. If the requestor is not authorized to view the subject matter of the linked documents, the affected links are identified at block 50 and information pertaining to the links is again forwarded to the document processor 32. At block 52 of the method 40, the request is further processed to determine if any restrictions based upon time limitations should apply to the links in the requested document. If so, the affected links are identified at block 54 and transferred to the document processor 32.

At block 55, the request is processed to determine if the requestor may access all documents linked to the requested document based upon the location of the client device 12 (of FIG. 1). If the requestor is not authorized to view the linked documents because the client device 12 is not properly located, or cannot communicate over a secure network, the affected links are identified at block 56 and information pertaining to the links is again forwarded to the document processor 32. At block 58, an appropriate document overlay is prepared in the document processor 32 using the information generated at blocks 50, 54 and 56, where the requested document may then be processed to disable the links identified at blocks 50, 54 and 56. Alternately, the document overlay may be transferred to the client device 12 and applied to the requested document at the client device 12. If no restrictions are detected by the method 40, the document is transferred to the client device 12 with all links to other documents enabled, as shown at block 57.

In the foregoing discussion of the method 40, it was assumed that the links in the document were enabled at block 42, and that a portion of the links in the requested document were successively disabled. One skilled in the art will readily understand that the links in the requested document may also be disabled at the outset of the method 40, and successively enabled by the method 40. Additionally, the method 40 is shown in FIG. 3 with the blocks 44, 48, 52 and 55 serially arranged. One skilled in the art will also recognize that the blocks 44, 48, 52 and 55 may also be arranged in parallel, so that each of the blocks 44, 48, 52 and 55 may be executed in parallel. Alternately, the blocks of the method 40 may be serially arranged in any suitable order.

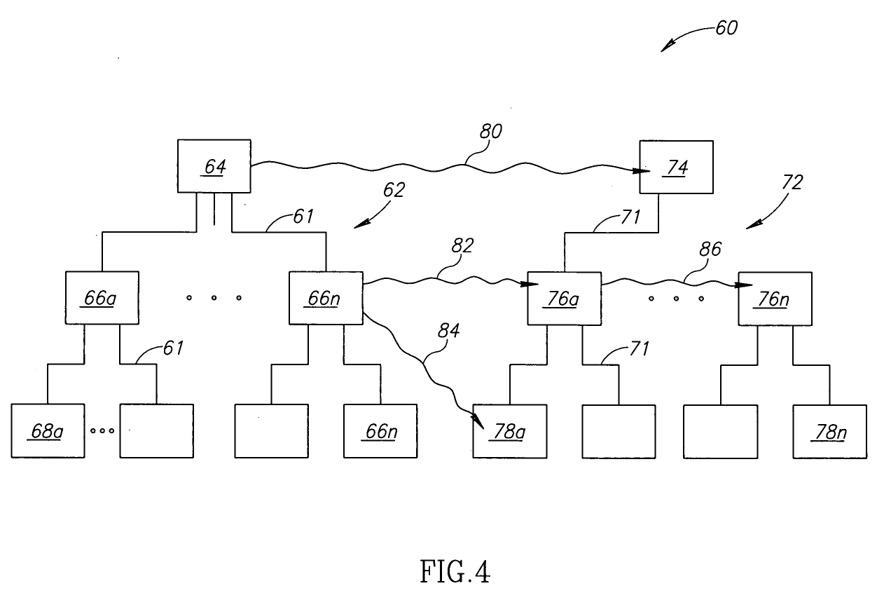

FIG. 4 is a graphical representation of a plurality of hierarchical document trees that will be used to describe a method 60 of selectively linking documents according to another embodiment of the invention. The method 60 includes a first document tree 62 having a root 64, branches 66a through 66n that depend from the root 44, and various sub-branches that depend from the branches 66a through 66n. For clarity of illustration, only sub-branches 68a through 68n, which depend from branch 66n are shown. One skilled in the art will readily understand that other sub-branches may be present, which may have still other branches depending therefrom. The root 64, branches 66a through 66n and the sub-branches 68a through 68n are connected by pre-existing paths 61 that stem from the authorship of the document. For example, where the root 64 is a table of contents for the document, the branches 66a through 66n may represent chapters listed in the table of contents, so that the links 61 comprise paths between the table of contents and the subject matter comprising each chapter.

A second document tree 72 similarly includes a root 74, branches 76a through 76n that depend from the root 74, and various sub-branches that depend from the branches 76a through 76n. Again, for clarity of illustration, only sub-branches 78a through 78n, which depend from branch 76n are shown. The root 74, branches 76a through 76n and the various sub-branches 78a through 78n are connected by pre-existing paths 71 that stem from the structure of the document. A link 80 embedded in the root 64 links the root 64 of the first tree 62 to the root 74 of the second tree 72. Similarly, other links may connect other portions of the first tree 62 and the second tree 72. For example, a link 82 and a link 84 may be embedded in the branch 66n to link the branch 66n to the branch 76a and the sub-branch 78a of the second document tree 72, respectively. Other links may also be present within a document tree. For example, link 86 may link branch 76a to branch 76n within the second document tree 72, and provides the only path from the branch 76a to the branch 76n.

The foregoing links 80, 82, 84 and 86 form referential paths between the first document tree 62 and the second document tree 72. If a document requestor is permitted access to the first document tree 62, but is not permitted to access any portion of the second document tree 72, the links 80, 82 and 84 are accordingly disabled. In other instances, the document requestor may access selected portions of the second document tree 72. For example, the links 80, 82 and 84 may be enabled, while the link 86 is selectively disabled, thus denying the document requestor access to the branch 76n of the second document tree 72, in addition to the sub-branches underlying the branch 76n. In all of the foregoing examples, the links between the first document tree 62 and the second document tree 72 may be selectively enabled and/or disabled by processing criteria associated with the document request, as discussed more fully in connection with FIG. 3.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A document management system, comprising:
a database configured to store one or more document trees having a plurality of referential links embedded therein;
a processor configured to communicate with the database and with one or more client devices operable to access selected portions of the one or more document trees and actuate selected links within the accessed portions of the one or more document trees; and
an information control unit coupled to the processor and configured to control a status of the referential links in the accessed portions according to predetermined criteria.

2. The document management system of claim 1, wherein the information control unit is configured to disable the referential links.

3. The document management system of claim 1, wherein the information control unit is configured to enable the referential links.

4. The document management system of claim 1, wherein the processor further comprises a request processor coupled to the information control unit, the request processor being operable to receive a document request from the one or more client devices and compare the request with link access information obtained from the information control unit.

5. The document management system of claim 3, wherein the processor further comprises a document processor coupled to the request processor, the document processor being operable to receive a document from the database and process the received document according to link access information obtained from the information control unit.

6. The document management system of claim 5, wherein the document processor is further configured to generate a document overlay that is applied to the document that selectively enables selected links in the document.

7. The document management system of claim 5, wherein the document processor is further configured to generate a document overlay that is applied to the document that selectively disables selected links in the document.

8. The document management system of claim 1, further comprising a communications network that couples the processor and the one or more client devices.

9. The document management system of claim 8, wherein the communications system comprises a global computer communications system.

10. The document management system of claim 1, wherein the one or more document trees include hypertext documents, and the embedded links are hyperlinks.

11. A method of selectively altering a status of a referential link, comprising:
initiating a document request from a database that includes a plurality of document trees having embedded referential links;
reviewing access information associated with the document request;
altering the status of one or more referential links in the requested document based upon the access information; and
transferring the requested document to a client device coupled to the database.

12. The method of claim 11, wherein initiating a document request further comprises submitting the document request to a request processor configured to at least review an identity of a requestor of the document and an identity of the document.

13. The method of claim 11, wherein reviewing access information associated with the document request further comprises examining an identity of a requester and identifying an affected link based upon the requestor's identity.

14. The method of claim 11, wherein reviewing access information associated with the document request further comprises examining a subject matter of the document and identifying an affected link based upon the subject matter.

15. The method of claim 11, wherein reviewing access information associated with the document request further comprises examining a time limitation of the document and identifying an affected link based upon the time limitation.

16. The method of claim 11, wherein reviewing access information associated with the document request further comprises examining a physical location of the requestor and identifying an affected link based upon the physical location.

17. The method of claim 11, wherein altering the status of one or more referential links in the requested document includes processing the document in a document processor that selectively enables the embedded links.

18. The method of claim 11, wherein altering the status of one or more referential links in the requested document includes processing the document in a document processor that selectively disables the embedded links.

19. The method of claim 11, wherein altering the status of one or more referential links in the requested document includes generating a document overlay that selectively alters the status of the embedded links.

20. The method of claim 11, wherein transferring the requested document to a client device further comprises transferring the requested document to the client device through a communications system.

21. The method of claim 11, wherein transferring the requested document to a client device further comprises generating a document overlay that selectively alters the status of the embedded links, and transferring the document overlay to the client device.

22. The method of claim 11, wherein the plurality of document trees comprise hypertext documents, and wherein altering the status of one or more referential links in the requested document further comprises altering the status of one or more hyperlinks.

23. A method of selectively linking documents, comprising:
submitting a document access request for a selected portion of a first document tree having a plurality of referential links embedded therein;
accessing the selected portion of the first document tree;
selecting a referential link in the selected portion; and
determining a status of the link based upon access information associated with the access request.

24. The method of claim 23, wherein submitting a document access request for a selected portion of a first document tree further comprises processing criteria associated with the document request.

25. The method of claim 24, wherein processing criteria associated with the document request further comprises transferring the document request to a request processor configured to at least examine the identity of a requestor of the document and an identity of the document.

26. The method of claim 23, wherein submitting a document access request for a selected portion of a first document tree further comprises examining a requestor's identity and identifying an affected link based upon the requestor's identity.

27. The method of claim 23, wherein submitting a document access request for a selected portion of a first document tree further comprises examining a subject matter of the document and identifying an affected link based upon the subject matter.

28. The method of claim 23, wherein submitting a document access request for a selected portion of a first document tree further comprises examining a time limitation of the document and identifying an affected link based upon the time limitation.

29. The method of claim 23, wherein submitting a document access request for a selected portion of a first document tree further comprises examining a physical location of a requestor and identifying an affected link based upon the physical location.

30. The method of claim 23, wherein determining a status of the link based upon access information comprises processing the document in a document processor that selectively enables the embedded links.

31. The method of claim 23, wherein determining a status of the link based upon access information comprises processing the document in a document processor that selectively disables the embedded links.

32. The method of claim 23, wherein determining a status of the link based upon access information associated with the access request further comprises generating a document overlay that selectively alters the status of the embedded links.

33. The method of claim 23, further comprising transferring the requested document to a client device through a communications system.

34. The method of claim 33, wherein transferring the requested document to a client device further comprises generating a document overlay that selectively alters the status of the embedded links, and transferring the document overlay to the client device.

35. A method of providing document access to an aircraft operator, comprising:
initiating a document request from a database that includes a plurality of document trees having information related to the operation and maintenance of an aircraft;
reviewing access information associated with the aircraft operator;
changing the status of one or more referential links in the requested document based upon the reviewed access information; and
communicating the requested document to the aircraft operator.

36. The method of claim 35, wherein initiating a document request further comprises submitting the document request to a request processor configured to at least review an identity of a requestor of the document and an identity of the document.

37. The method of claim 35, wherein reviewing access information associated with the document request further comprises examining an identity of a requester and identifying an affected link based upon the requestor's identity.

38. The method of claim 35, wherein reviewing access information associated with the document request further comprises examining a subject matter of the document and identifying an affected link based upon the subject matter.

39. The method of claim 35, wherein reviewing access information associated with the document request further comprises examining a time limitation of the document and identifying an affected link based upon the time limitation.

40. The method of claim 35, wherein reviewing access information associated with the document request further comprises examining a physical location of the requestor and identifying an affected link based upon the physical location.

41. The method of claim 35, wherein changing the status of one or more referential links in the requested document includes processing the document in a document processor that selectively enables the embedded links.

42. The method of claim 35, wherein changing the status of one or more referential links in the requested document includes processing the document in a document processor that selectively disables the embedded links.

43. The method of claim 35, wherein changing the status of one or more referential links in the requested document includes generating a document overlay that selectively alters the status of the embedded links.

44. The method of claim 35, wherein communicating the requested document to the aircraft operator comprises transferring the requested document to the aircraft operator through a communications system.

45. The method of claim 35, wherein communicating the requested document to the aircraft operator further comprises generating a document overlay that selectively alters the status of the embedded links, and transferring the document overlay to the aircraft operator.

46. The method of claim 35, wherein the plurality of document trees comprise hypertext documents, and wherein changing the status of one or more referential links in the requested document further comprises altering the status of one or more hyperlinks.
